(19) United States
(12) Patent Application Publication
(10) Pub. No.: US 2011/0094626 A1
(43) Pub. Date: Apr. 28, 2011

(54) Wooden sports articles and a method of manufacture

(76) Inventors: Frederick Roy Bonds, Mt. Pleasant, MI (US); Derek Michael Bonds, Mt. Pleasant, MI (US)

(21) Appl. No.: 12/657,521

(22) Filed: Jan. 22, 2010

Related U.S. Application Data
(60) Provisional application No. 61/279,890, filed on Oct. 27, 2009.

(51) Int. Cl. B27M 3/22; A63B 59/06; A63B 59/14; A63B 59/00; A63B 59/02; A63B 59/04; A63B 59/08; F26B 7/00

(52) U.S. Cl. 144/329; 473/564; 473/560; 473/524; 473/513; 473/527; 473/565; 34/380

(57) ABSTRACT

Novel sports articles are manufactured from acetylated wood. There is a process for manufacturing such articles from acetylated wood involving treating wood billets with the acetylation process and then shaping them into the desired sport article and then finishing the article with some durable finish such as varnish or shellac.

This application claims priority from U.S. Provisional patent Application No. 61/279,890, filed on Oct. 27, 2009.

The invention disclosed and claimed herein deals with novel sports articles that are manufactured from Acetylated wood. It further deals with a method of manufacturing such articles from acetylated wood.

It has been found that sports articles manufactured from such wood provides sports articles that are durable and do not break under normal use conditions as is common with bats and hockey sticks and the like.

### BACKGROUND OF THE INVENTION

In many sports activities, there are certain articles that need to be employed to play the sport. Such activities, for example, include baseball and softball in which bats are used to hit the balls. Other such sports are tennis and lacrosse that use rackets and ice hockey that uses hockey stick. Also contemplated within the scope of this invention are table tennis paddles, badminton racquets, and cricket paddles.

Currently, these articles are made from wood or from plastic where the rules of the sport allow. However, both of these forms of the articles are subject to breakage and it is common to observe, for example, a baseball player swing at a pitched ball and break the bat when contact is made between the bat and the ball. This breakage is dangerous ranging from portions of the broken bat hitting players or fans, to sharp pieces of the broken bat piercing the players hands and arms.

There is currently a new wood that is available that is wood that has been treated by a process of acetylation which provides the wood with durability, dimensional stability, enhanced hardness, and resistance to moisture contamination.

This process is the subject of a International Patent Application No. PCT/GB2009/000268, that was filed on Jan. 30, 2009.

The inventors therein discovered that certain ordinary woods (not all woods are capable of being so-treated) can be treated by a process of acetylation in which wood having a certain moisture content is submerged in a vessel containing an acetylation fluid, at a certain temperature, and pressurizing the fluid and wood. Woods that are known as being capable of treatment in this manner include, but are not limited to, radiata pine, alder, soft maple, European beech and the like.

Thereafter, excess acylation fluid is removed from the treating vessel and an inert fluid is introduced which causes an exotherm of the wood and fluid. Thereafter, the fluid and wood are heated a second time to cause another exotherm and then the wood is removed from the fluid and allowed to cool.

The inventors herein have found that such wood can be manufactured to provide sports articles as set forth Supra, that have exceptional properties, among which, is a capability of being used in sports activities without breaking.

### THE INVENTION

Thus, the invention herein consists of a wooden sports article manufactured from acetylated wood. In another embodiment, there is a process of manufacturing wooden sports articles from acetylated wood.

As mentioned Supra, any sports article that is currently made from plastic or wood can be duplicated by using acetylated wood as it have been discovered that such wood can be shaped on conventional mechanical equipment.

The process for making the sports articles comprises providing billets of suitable hardwood and then kiln drying them to the required moisture content for the acetylation process to occur optimally. The kilned billets are then processed in the acetylation chambers according to the patented process. Once completed, the billets are then appropriately shaped as required for a particular article and then finished.

For example, ball bats are turned on lathes to the appropriate shape and then finished with a finish material and allowed to dry.

Thus, with more specificity, the process for manufacturing a sports article comprises providing wood billets of a predetermined size and drying the billets to a moisture content suitable for an acetylation process as described in the aforementioned PCT application.

Acetylating the wood billets according to the acetylation Process and then drying the wood billets and thereafter, shaping the wood billets according to a predetermined shape into a predetermined sports article.

The final step is applying finishes to the shaped sports article and then allowing the finishes to dry.

The nominal size of the billets for use herein are those that will result in the desired size and shape of the sport article desired. For example, billets of 3 inches×3 inches, by 38 inches is suitable for a bat.

### BRIEF DESCRIPTION OF THE DRAWINGS

FIG. 1 is a full view of a soft ball bat manufactured according to the invention.

FIG. 2 is a full view of a baseball bat manufactured according to the invention.

FIG. 3 is a full view of a hockey stick manufactured according to the invention.

FIG. 4 is a full view of a tennis racquet whose frame and handle are manufactured according to the invention.

FIG. 5 is a full view of a table tennis paddle whose handle and blade are manufactured according to the invention.

FIG. 6 is a full view of a badminton racquet whose frame and handle are manufactured according to the invention.

FIG. 7 is a full view of a cricket paddle manufactured according to the invention.

### DETAILED DESCRIPTION OF THE DRAWINGS

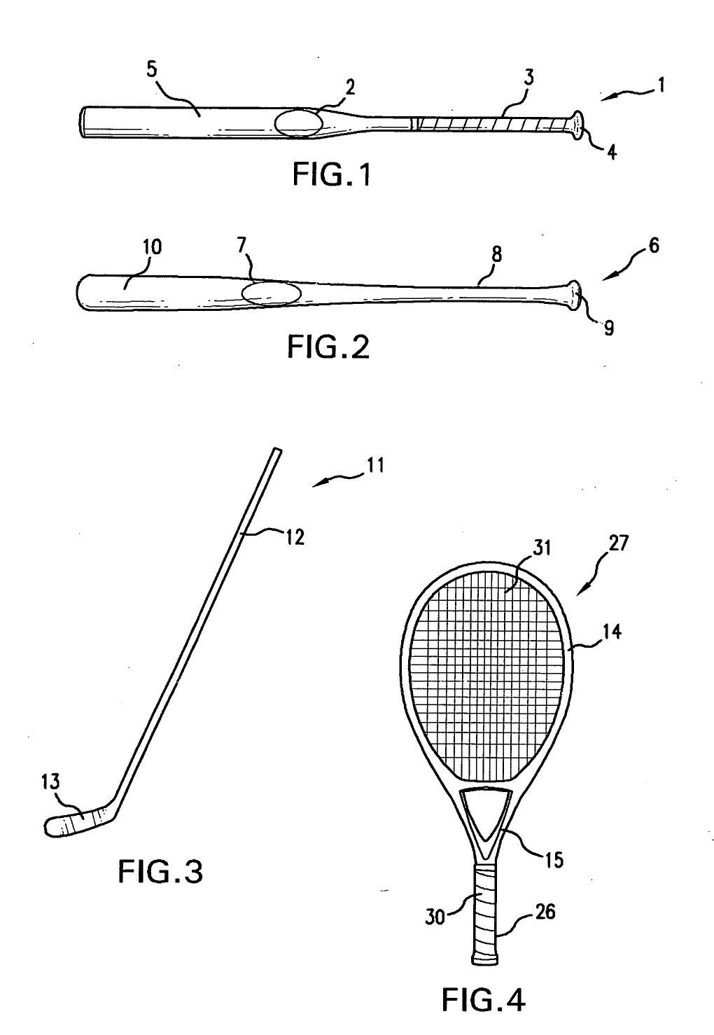

FIG. 1 is a full view of a softball bat 1 manufactured from acetylated wood showing the crest 2, the handle 3, the knob 4 and the hitting area 5.

FIG. 2 is a full view of a baseball bat 6 manufactured from acetylated wood showing the crest 7, the handle 8, the knob 9, and the hitting area 10.

FIG. 3 is a full view of a hockey stick 11 manufactured according to the invention in which there is shown the handle 12 and the blade 13.

FIG. 4 is a full view of a tennis racquet 27 whose frame 14 and handle 15 are manufactured from acetylated wood according to the invention. Also shown is a padded grip 30 and stringing 31.

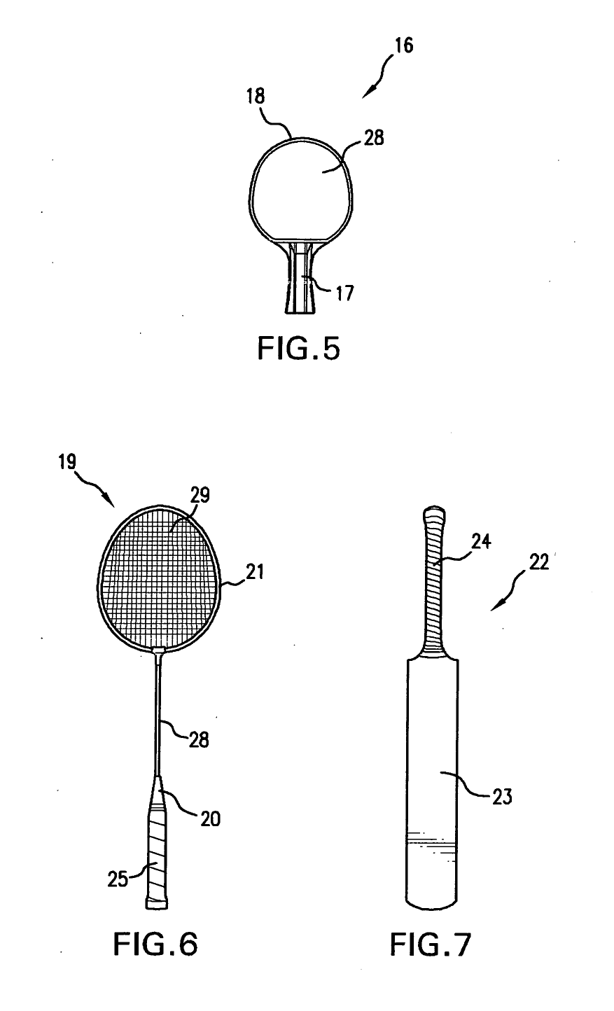

FIG. 5 is a full view of a table tennis paddle 16 whose handle 17 and blade 18 are manufactured from acetylated wood according to the invention. Also shown is the pad 28.

FIG. 6 is a full view of a badminton racquet 19 whose handle 20, shaft 28, and frame 21 are manufactured from acetylated wood according to the invention. Also shown is a padded grip 25 on the handle 20. Also shown is the stringing 29.

FIG. 7 is a full view of a cricket paddle 22 manufactured from acetylated wood according to the invention showing the blade 23 and the handle 24.

### EXAMPLE

A baseball bat manufactured from an acetylated European beech wood produced a baseball bat of superior performance and durability as compared to a baseball bat manufactured from natural wood.

What is claimed is:

1. A wooden sports article manufactured from acetylated wood.

2. A wooden sports article as claimed in claim 1 that is a baseball bat.

3. A wooden sports article as claimed in claim 1 that is a softball bat.

4. A wooden sports article as claimed in claim 1 that is a hockey stick.

5. A wooden sports article as claimed in claim 1 that is a tennis racket.

6. A wooden sports article as claimed in claim 1 that is a lacrosse racket.

7. A wooden sports article as claimed in claim 1 that is a table tennis paddle.

8. A wooden sports article as claimed in claim 1 that is a badminton racquet.

9. A wooden sports article as claimed in claim 1 that is a cricket paddle.

10. A process for manufacturing a sports article, said process comprising:
a. providing wood billets of a predetermined size;
b. drying the billets to a moisture content suitable for an acetylation process;
c. acetylating the wood billets according to the acetylation process;
d. drying the wood billets;
e. shaping the wood billets according to a predetermined shape into a predetermined sports article;
f. applying finishes to the shaped sports article and then allowing the finishes to dry.
